(19) United States
(12) Patent Application Publication
(10) Pub. No.: US 2002/0117905 A1
(43) Pub. Date: Aug. 29, 2002

(54) Linear actuator

(75) Inventor: Akio toba, Tokyo (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJI ELECTRIC CO. LTD.

(21) Appl. No.: 10/083,188

(22) Filed: Feb. 26, 2002

(30) Foreign Application Priority Data
Feb. 28, 2001 (JP) 2001-055271
Dec. 13, 2001 (JP) 2001-379971

(51) Int. Cl. H02K 41/00

(52) U.S. Cl. 310/12

(57) ABSTRACT

A first component (a stator) is formed by a magnetic substance, centrally wound by a coil at an end portion in the longitudinal direction of a plurality of pieces, and periodically makes a magnetic change along the longitudinal direction of the plurality of pieces by passing an electric current through the coil. A second component (a mover) faces the first component at predetermined spacing, and has N and S magnetic poles along the longitudinal direction of the plurality of pieces. The second component can be moved relative to the first component along the longitudinal direction of the first component by differentiating the distribution of magnetic changes of the plurality of pieces of the first components on the surface facing the second component. Thus, the movable range of the mover can be extended, the cooling structure of the coil can be simplified, and the total cost can be reduced.

### BACKGROUND OF THE INVENTION

1. Field of the Invention

The present invention relates to a linear actuator for shifting the distribution of the magnetic change on the facing surface between a first component and a second component, and applying magnetic force to the magnetic pole of the second component, thereby relatively and linearly moving the first component and the second component.

2. Description of the Related Art

FIG. 1A shows the first conventional technology referred to as a 3-phase fixed coil linear actuator.

In FIG. 1A, a mover 60 faces a stator 70 at predetermined spacing on average, and the mover 60 can be movable along a supporter (called a linear guide) not shown in the attached drawings.

The mover 60 is formed by a core 61 and a number of magnetic poles 62 in which an S pole and an N pole are alternately magnetized and arranged on the surface facing projections 73 of the stator 70. The structure of the mover is not limited to the example shown in FIG. 1A so far as the N pole and the S pole are alternately arranged in the array direction of the projections 73 of the stator 70.

On the other hand, the stator 70 is provided with main poles 72 coupled by a back yoke 71. The projections 73 are provided on the top surfaces of the main poles 72. Each main pole 72 is wound with a coil 74, and the coil 74 is provided in the slot between the main poles. The unit including the main pole 72, the projection 73, and the coil 74 forms each phase. The U-phase, V-phase, and W-phase coils 74 are arranged in order.

Described below are their operations. For example, if an electric current is applied to the U-phase coil of the stator 70 shown in FIG. 1A such that the U-phase projections can form the N poles, then the S poles of the magnetic poles 62 of the mover 60 are attracted to the U-phase projections. If an electric current is applied to the W-phase coil such that the W-phase projections can form the S poles with the electric current of the U-phase coil set to 0, then the force by which the N poles of the magnetic poles 62 are attracted to the W-phase projections is generated, thereby linearly and horizontally moving the mover 60.

The above mentioned operations are continuously repeated for the U, V, and W phases so that thrust can be continuously produced along the X direction shown in FIG. 1A on the mover 60, thereby realizing the operations of the linear actuator.

FIG. 1B shows the second conventional technology referred to as a 3-phase movable coil linear actuator or a hybrid linear pulse motor.

In FIG. 1B, a rail-shaped stator 90 is provided with two rows of projections 92 arranged at regular spacing on a back yoke 91, and the projections 92 in each row are shifted from those in the other row when they are viewed from the side.

A mover 80 faces the stator 90 above the projections at predetermined spacing on average. The projections 83 are also provided on the facing surface of the mover 80 to the stator 90. These projections 83 are provided at the tip portions of three main poles 82, and each main pole 82 is connected through a back yoke 81. The back yoke 81 and the main pole 82 are formed by two same-shaped portions. These two portions are connected through a magnet 85 closely attached to them at the back yoke 81. The projections 83 of each portion face the projections 92 in the two rows of the stator 90. The magnetizing direction of the magnet 85 is normal to the side of the back yoke 81.

The three main poles 82 are wound with U, V, and W coils 84 respectively.

The above mentioned second conventional technology are well known, and the principle of the operations is described in, for example, ‘Illustrated Linear Servomotor and System Design’ (by Shiraki and Miyao, published by General Electronics Publications), p.115˜118. Therefore, the explanation is omitted here.

Described below is the third conventional technology referred to as a two-phase fixed coil linear actuator. This actuator is published by, for example, the Japanese Patent Publication No. 1495069 (Linear Pulse Motor) with a permanent magnet attached to the stator to increase the thrust.

In addition, the feature of the conventional technology is that the length of the mover along the movement direction is equal to or larger than the length of the stator along the direction, that the movable length is relatively short, and that the actuator is small and used in a positioning process.

In the above mentioned conventional technology, the position of a mover can be more correctly controlled by applying an electric current to the coil of a stator or a mover according to the positional information of the mover obtained by a position detector (for example, a linear encoder) attached to the mover.

Furthermore, the thrust of a mover can be smoothed not by switching the pulse of a current, but by using a continuous waveform such as a polyphase sine wave alternating current, etc. In the first and second conventional technology, the number of phases is not limited to three, but any integer equal to or larger than two can be applied to the number of phases.

As described above, various linear actuators have been suggested, but each of the conventional technology has the following problems.

First, according to the first conventional technology, the coil 74 has to be provided for all stators 70, but only the portion directly facing the movers 60 can contribute to the production of the thrust. Therefore, with a longer stator 70, the number of coils 74 increases, and the majority of the coils do not contribute to the production of the thrust, thereby incurring a higher cost, a heavier weight, and the necessity to provide a mechanism for cooling and radiating means for all the coils 74.

According to the second conventional technology, cable is required to pass an electric current through the coil 84 of the mover 80. Therefore, the mechanism becomes complicated in wiring, etc. In addition, since a relatively small mover incurs electric current losses, it is difficult to successfully dissipate heat, thereby enlarging and complicating a cooling structure.

Furthermore, although the third conventional technology has the merit that a coil can be centrally provided on the stator side, the mover is longer than the stator. Therefore, it cannot be applied to the purpose requiring a wider movable range. Additionally, according to the third conventional technology, the number of phases cannot be three or more to advantageously smooth the thrust.

### SUMMARY OF THE INVENTION

The present invention aims at providing a linear actuator capable of moving in a wider range, simplifying the cooling structure, and reducing the entire cost.

The linear actuator according to the present invention includes a stator and a mover.

According to the first aspect of the present invention, a stator is formed by winding a coil around an end portion of a rail-shaped magnetic substance, and a mover faces the rail portion of the stator, can move relatively along the rail portion, and includes a magnetic substance. The linear actuator according to the present invention can produce electromagnetic thrust of the mover by passing an electric current through the coil and centrally generating magnetic flux around the rail-shaped portion facing the mover.

### BRIEF DESCRIPTION OF THE DRAWINGS

The present invention will become more apparent from the following description of the preferred embodiments, with reference to the accompanying drawings, in which:

FIG. 1A shows the first conventional technology;

FIG. 1B shows the second conventional technology;

FIG. 2A shows the first embodiment of the present invention;

FIG. 2B shows the electric voltage and current applied to the coil according to the first embodiment of the present invention;

FIG. 3 shows the operation according to the first embodiment of the present invention;

FIG. 4 shows the concept of the present invention according to the third aspect of the present invention;

FIG. 5 shows the second embodiment of the present invention;

FIG. 6 shows the electric voltage and current applied to the coil according to the second embodiment of the present invention;

FIG. 7 shows the third embodiment of the present invention;

FIG. 8 shows the fourth embodiment of the present invention;

FIG. 9 shows the operation according to the fourth embodiment of the present invention;

FIG. 10 shows the fifth embodiment of the present invention;

FIG. 11 shows the sixth embodiment of the present invention;

FIG. 11 shows the sixth embodiment of the present invention;

FIG. 12 shows the seventh embodiment of the present invention;

FIG. 13 shows the eighth embodiment of the present invention;

FIG. 14 shows the ninth embodiment of the present invention;

FIG. 15 shows the tenth embodiment of the present invention; and

FIG. 16 shows the type of the relative position between the magnetic pole of the mover piece and the projection of the stator piece.

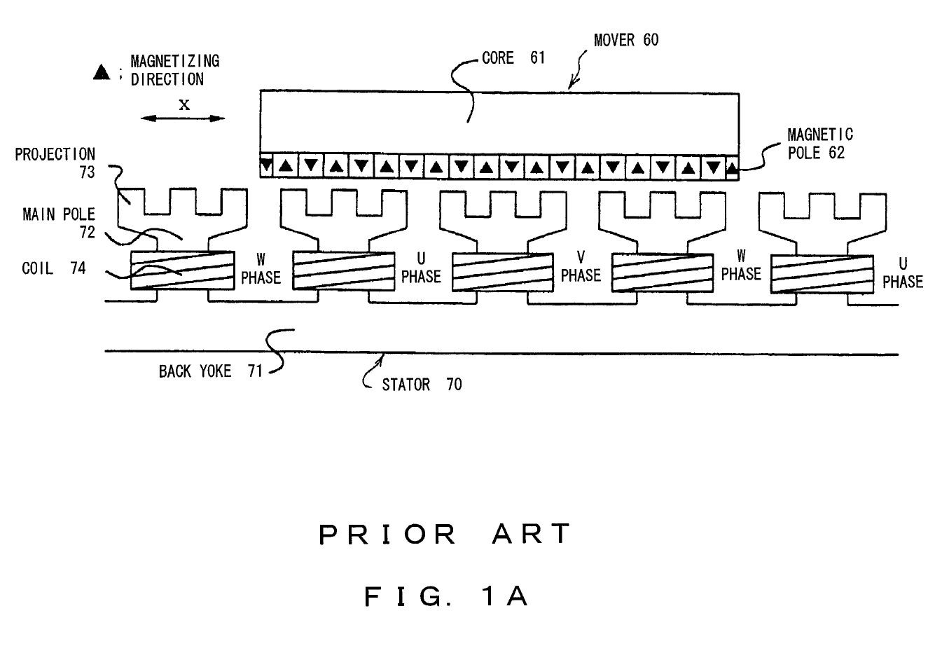

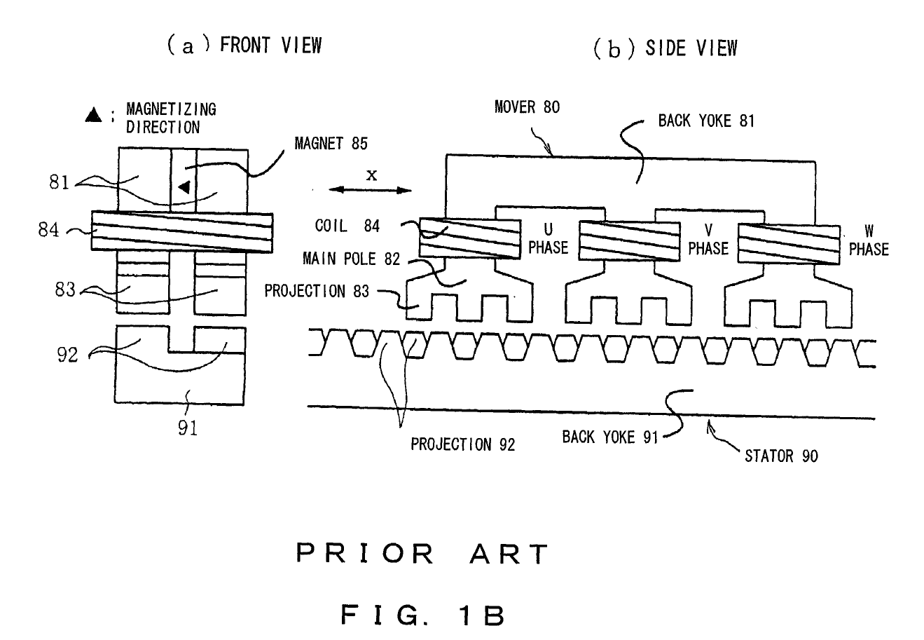

### DESCRIPTION OF THE PREFERRED EMBODIMENTS

Embodiments of the present invention are described below in detail by referring to the attached drawings.

To solve the above mentioned problems with the conventional technology, the first aspect with the basic configuration of the present invention comprises: a stator having a coil wound around the end portion of a rail-shaped magnetic substance; and a mover which faces the rail-shaped portion of the stator, relatively moves along the rail-shaped portion, and includes a magnetic substance. With the configuration, an electric current flows through the coil to centrally produce magnetic flux on the rail-shaped portion facing the stator, thereby obtaining magnetic thrust of the mover.

The present invention described above can be embodied as follows.

That is, the second aspect of the present invention comprises: a first component which is formed by rail-shaped magnetic pieces in substantially parallel rows, each of which has a coil wound around at an end portion of a longitudinal direction of the piece and makes a periodical magnetic change along the longitudinal direction of the piece by flowing an electric current through the coil; and a second component (for example, a mover) facing the first component at predetermined spacing, and having N and S magnetic poles along the longitudinal direction of the plurality of pieces. With the configuration, the second component can be moved relative to the first component along the longitudinal direction of the first component by differentiating the distribution of magnetic changes of the plurality of pieces of the first components on the surface facing the second component.

The second aspect of the present invention can be more effectively embodied according to the following third through eleventh aspects of the present invention.

That is, the third aspect of the present invention comprises: a stator having K (K indicates and integer equal to or larger than 2) stator piece pairs, and each stator piece pair is composed of two stator pieces which are parallel-placed rail-shaped magnetic substances having a plurality of projections arranged at regular spacing T in a longitudinal direction, a bridge made by magnetic substance connecting one end of each stator piece together magnetically, and a coil wound around the bridge to magnetize the two stator pieces for opposite polarities; and a mover having K mover piece pairs, and each mover piece pair is composed of magnetically-connected two mover pieces which are faced at predetermined spacing to said two stator pieces one to one which comprise said stator piece pair, and each mover piece has a magnetic core and magnetic poles formed on a portion of the magnetic core facing to said stator piece and arranged such that all or part of the N poles face to projections of the stator piece when all or part of the S poles face to slots between the projections. With each of K sets of one stator piece pair and one mover piece pair facing to each other, two sets of a stator piece and a mover piece facing to each other are arranged such that positions of the magnetic poles on the mover piece to the projections on the stator piece in one set are shifted relative to those of the other set by T/2 in the longitudinal direction of said stator. Simultaneously, with the K sets of one stator piece pair and one mover piece pair, the positions of the magnetic poles on the mover pieces to the projections on the stator pieces are sequentially shifted relative to each other at regular spacing along the longitudinal direction of the stator. Thus, the thrust along the longitudinal direction of the stator can be produced on the mover by sequentially applying an electric current to a coil of each stator piece pair in a time series.

According to the fourth aspect of the present invention based on the linear actuator according to the third aspect of the present invention, the stator piece pair is formed such that the projections of its two stator pieces face to each other. The mover piece pair is provided between the two stator pieces in the stator piece pair corresponding to the mover piece pair.

The fifth aspect of the present invention comprises: a stator having M (M indicates an integer equal to or larger than 3) stator pieces, each of which is formed by a rail-shaped magnetic substance having a plurality of projections arranged at regular spacing in the longitudinal direction, and which are arranged parallel to each other, with one end of the stator pieces magnetically connected, and with a coil situated to each of the stator pieces to magnetize the projections; and a mover having M mover pieces, which are faced at predetermined spacing to said stator pieces one to one, and each mover piece has a magnetic core, which is magnetically-connected to the cores of adjacent mover pieces, and magnetic poles formed on a portion of the magnetic core facing to said stator piece and arranged such that all or part of the N poles face to projections of the stator piece when all or part of the S poles face to slots between the projections. With M sets of one stator piece and one mover piece facing to each other, the positions of the magnetic poles on the mover pieces to the projections on the stator pieces are sequentially shifted relative to each other at regular spacing along the longitudinal direction of said stator. Thus, the thrust along the longitudinal direction of the stator can be produced on the mover by sequentially applying an electric current to a coil of each stator piece in a time series.

In the sixth aspect of the present invention based on the linear actuator according to one of the third through fifth aspects of the present invention, the mover piece is configured by closely coupling a core of a strong magnetic substance with a permanent magnet as a magnetic pole.

In the seventh aspect of the present invention based on the linear actuator according to one of the third through sixth aspects of the present invention, the bridge to connect the stator pieces magnetically and said coils are also provided at the other end of the stator.

In the eighth aspect of the present invention based on the linear actuator according to one of the third through seventh aspects of the present invention, a sensor coil is wound in the slot between the projections of the stator pieces, and the absolute position of the mover can be detected based on the change of the inductance of the sensor coil made when the mover passes over the sensor coil.

In the ninth aspect of the present invention based on the linear actuator according to the eighth aspect of the present invention, the sensor coil is configured by a part of a coil for driving the mover wound around the bridge of the stator.

In the tenth aspect of the present invention based on the linear actuator according to one of the third through ninth aspects of the present invention, said stator pieces are configured by laminated steel.

In the eleventh aspect of the present invention based on the linear actuator according to one of the third through tenth aspects of the present invention, said bridge is configured by laminated steel.

The embodiments of the present invention are described below by referring to the attached drawings. The first and second aspects of the present invention correspond to the invention including each embodiment, and can be embodied by the invention according to the third and subsequent aspects of the present invention.

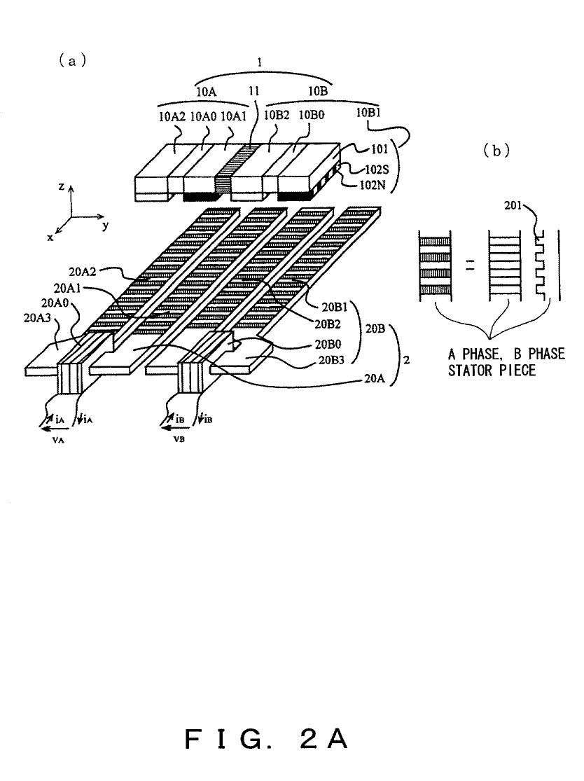

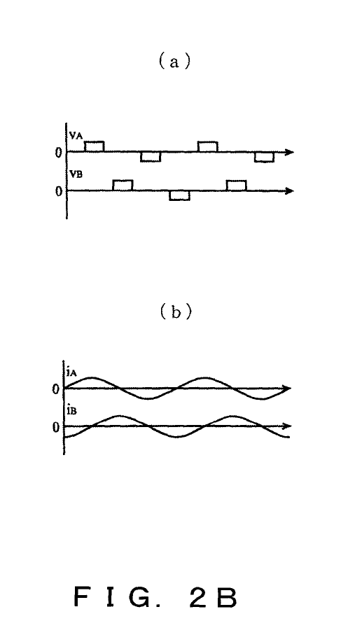

First, (a) in FIG. 2A is an oblique view showing the first embodiment of the third aspect of the present invention. (b) in FIG. 2A shows the central portion according to the embodiment of a 2-phase concentration coil linear actuator.

In FIG. 2A, a mover 1 is configured by providing an A-phase mover piece pair 10A obtained by magnetically coupling two mover pieces 10A1 and 10A2 through a bridge 10A0 formed by a strong magnetic substance parallel to a B-phase mover piece pair 10B having the same structure as the mover piece pair 10A along the x direction as shown in FIG. 2A with the mover piece pairs 10A and 10B combined as one unit by a spacer 11.

Since the mover piece pairs 10A and 10B have the same structures, the structure of each pair is described below in detail only by referring to the mover piece pair 10B.

First, in the B-phase mover piece pair 10B, one mover piece 10B1 has magnetic poles 102N and magnetic poles 102S alternately on the bottom surface of a core 101 at regular spacing P. Similarly, the other mover piece 10B2 has magnetic poles 102S and 102N having inverse polarity in the relative positions on the bottom surface of the core 101. That is, the magnetic pole 102S of the mover piece 10B2 exists in the line extended in the y direction of the magnetic pole 102N of the mover piece 10B1.

These mover pieces 10B1 and 10B2 are magnetically combined through a bridge 10B0 provided between their cores 101 such that they can be parallel to each other along the x direction.

A stator 2 is provided such that the A-phase stator piece pair 20A can be parallel to the B-phase stator piece pair 20B in the x direction.

An A-phase stator piece pair 20A has two rail-shaped stator pieces 20A1 and 20A2 formed by magnetic substances having the substantially the same structures parallel to each other along the x direction, and the stator pieces 20A1 and 20A2 are magnetically coupled through a bridge 20A3 of a strong magnetic substance formed as one unit at the end portions of the stator pieces 20A1 and 20A2. The central portion of the bridge 20A3 is wound with a coil 20A0 for magnetizing the stator pieces 20A1 and 20A2 into opposing magnetic poles.

In the stator pieces 20A1 and 20A2, in a range wider than the total length in the x direction of the magnetic poles arranged on the bottom surfaces of the mover pieces 10A1 and 10A2 facing the stator pieces 20A1 and 20A2, a plurality of projections 201 are formed at regular spacing T (P/2<T<2P: P indicates the magnetic pole spacing on the mover 1 as described above, and T=P according to the embodiment) as indicated by (b) shown in FIG. 2A. The projections 201 are arranged in the same positions along the x direction of the stator pieces 20A1 and 20A2. That is, the projections 201 of the stator 20A2 are provided in the line extended in the y direction of the projections 201 of the stator piece 20A1.

A B-phase stator piece pair 20B has almost the same configuration as the stator piece pair 20A. However, the positions of the projections 201 in the stator pieces 20B1 and 20B2 are generally shifted by ¼ pitch (1 pitch refers to the spacing T between adjacent projections 201) in the x direction relative to the position of the projections 201 in the stator pieces 20A1 and 20A2 of the A-phase stator piece pair 20A.

That is, the shift of the projections 201 between the stator pieces 20A1 and 20A2 of the A-phase stator piece pair 20A and the stator pieces 20B1 and 20B2 of the B-phase stator piece pair 20B is represented by T/(2K) where K is an integer equal to or larger than 2 and indicates the number of stator piece pairs, and T indicates the spacing T.

As described above, according to the embodiment, one mover piece pair corresponds to one stator piece pair, and the magnetic pole surface of the mover 1 faces the projection surface of the stator 2 at predetermined spacing on average. The mover 1 can move in the x direction. The guide mechanism for movement of the mover 1 can be realized by attaching the mover 1 to the supporter (not shown in the attached drawings) movable on the rail along the longitudinal direction of the stator 2.

Described below is the method of driving the linear actuator.

According to the embodiment, the continuous thrust can be produced in the mover 1 in the x direction by applying voltage pulses vA and vB as indicated by (a) shown in FIG. 2B to the terminals of the A- and B-phase coils 20A0 and 20B0, thereby operating the linear actuator.

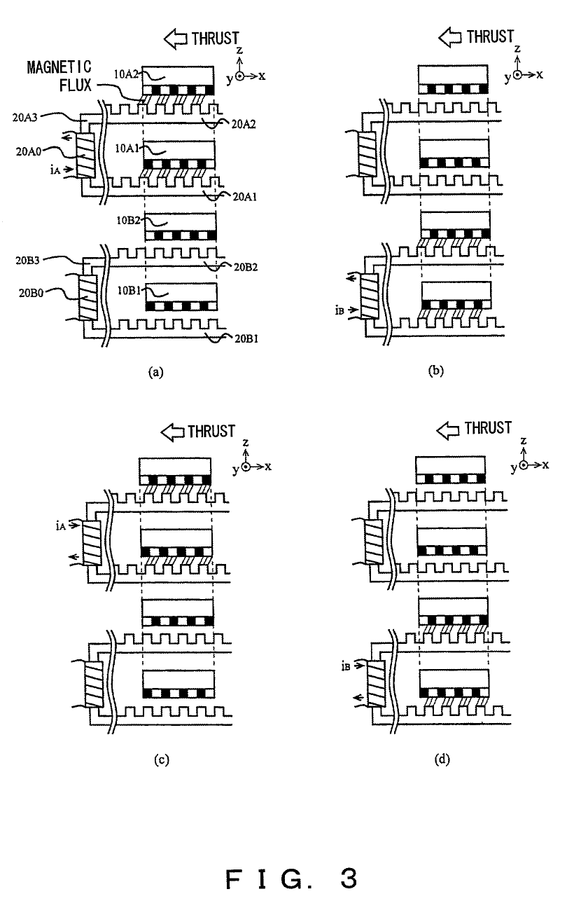

The principle of producing continuous thrust is described below by referring to the concept shown in FIG. 3. FIG. 3 is a list of sectional views of each piece of each phase of the stator 2 and the mover 1 with the positions arranged in the x direction. Although the type of the coil portion is also described to clearly show the exciting state of the coils 20A0 and 20B0, the display of the arrangement direction of this portion is different from the display of the mover portion.

When an electric current iA flows through the A-phase coil 20A0 in the state (a) shown in FIG. 3, the force to match the projections of the A-phase stator pieces 20A1 and 20A2 with the magnetic poles of the A-phase mover pieces 10A1 and 10A2 is produced in the relative positions between the mover 1 (the A-phase mover pieces 10A1 and 10A2 and the B-phase mover pieces 10B1 and 10B2) and the stator 2 (the A-phase stator pieces 20A1 and 20A2 and the B-phase stator pieces 20B1 and 20B2), and the force functions as the thrust to drive the mover 1, thereby moving the mover 1 into the position indicated by (b) shown in FIG. 3.

In (a) shown in FIG. 3, the projections of the B-phase stator pieces 20B1 and 20B2 match in position the magnetic poles of the B-phase mover pieces 10B1 and 10B2 while the projections of the A-phase stator pieces 20A1 and 20A2 are shifted by ¼ pitch from the magnetic poles of the A-phase mover pieces 10A1 and 10A2. Furthermore, in (b) shown in FIG. 3, the projections of the A-phase stator pieces 20A1 and 20A2 match in position the magnetic poles of the A-phase mover pieces 10A1 and 10A2 while the projections of the B-phase stator pieces 20B1 and 20B2 are shifted by ¼ pitch from the magnetic poles of the B-phase mover pieces 10B1 and 10B2.

When an electric current iB flows through the A-phase coil 20B0 in the state (b) shown in FIG. 3, the force to match the projections of the B-phase stator pieces 20B1 and 20B2 with the magnetic poles of the B-phase mover pieces 10B1 and 10B2 is produced, and the force functions as the thrust to drive the mover 1, thereby moving the mover 1 into the position indicated by (c) shown in FIG. 3. In this position, as in the case indicated by (a), the projections of the B-phase stator pieces 20B1 and 20B2 match in position the magnetic poles of the B-phase mover pieces 10B1 and 10B2 while the projections of the A-phase stator pieces 20A1 and 20A2 are shifted by ¼ pitch from the magnetic poles of the A-phase mover pieces 10A1 and 10A2.

In the state (c) shown in FIG. 3, when an electric current iA flows through the A-phase coil 20A0 in inverse direction to the case in (a), the mover 1 is moved into the position of (d) by the similar effect. In (d) shown in FIG. 3, as in the case of (b), the projections of the A-phase stator pieces 20A land 20A2 match in position the magnetic poles of the A-phase mover pieces 10A1 and 10A2 while the projections of the B-phase stator pieces 20B1 and 20B2 are shifted by ¼ pitch from the magnetic poles of the B-phase mover pieces 10B1 and 10B2.

In this state, if an electric current iB having the inverse polarity to the case of (b) is applied to the B-phase coil 20B0, then the relative position between the mover 1 and the stator 2 goes back to the state of 1 pitch of projection from (a).

Therefore, by differentiating the distribution of magnetic changes in the stator 2 by repeating the operations from (a) to (d) (that is, by generating magnetic flux alternately from the projections between the stator piece pairs), the mover 1 can be continuously moved by the thrust in the arrow direction.

In the above mentioned processes (a) through (d), the electric currents iA and iB flowing through the coils 20A0 and 20B0 can be realized by applying the voltage pulses vA and vB indicated by (a) shown in FIG. 2B. The electric current (or voltage) applied to the coils 20A0 and 20B0 can also have a waveform of a continuous and different phase, for example, a sine wave. As a result, the thrust can be smoothed.

In FIG. 2A, the magnetic pole position of the mover 1 is set in the y direction, the projections of the two stator pieces 20A1 and 20A2, and 20B1 and 20B2 are set to have inverse polarity in the stator piece pairs 20A and 20B, and the positions of the projections of the two stator piece pairs 20A and 20B are shifted by ¼ pitch from each other in the x direction.

Basically, if the A- and B-phase coil induced voltages from magnetic poles of a mover obtained when the mover is moved have an alternate current waveform having a phase difference, then an arbitrary configuration can be used.

Various configurations can be used by, for example, aligning the projections of all stator piece pairs 20A1, 20A2, 20B1, and 20B1 in the y direction (that is, no pitch shift is allowed in the x direction), and shifting by ¼ pitch the positions of the magnetic poles of the two mover piece pairs 10A and 10B in the x direction; aligning the magnetic poles and polarity of all mover pieces 10A1, 10A2, 10B1, and 10B2 in the x direction, and shifting by ½ the positions of the projections of the two stator piece pairs 20A1 and 20A2, and 20B1 and 20B1 of the stator piece pairs 20A and 20B (shifting by ½ pitch the positions of the projections of the stator piece 20A1 from the positions of the projections of the stator piece 20A2, and shifting by ½ pitch the positions of the stator piece 20B1 from the positions of the projections of the stator piece 20B2); shifting by ¼ the stator piece pair 20A from 20B, etc.

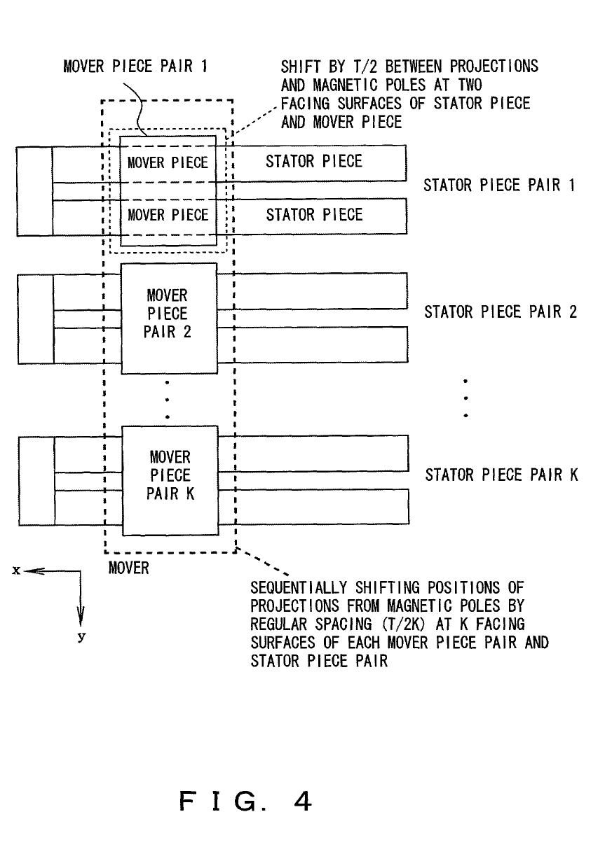

FIG. 4 shows the concept of the above mentioned processes (the positions of the projections of stator piece pairs are to be relatively shifted from the positions of the magnetic poles of mover piece pairs.

That is, according to the present invention, two sets of stator pieces and mover pieces in each of the K sets of K stator piece pairs and K mover piece pairs respectively facing the K stator piece pairs, the positions of the projections of the stator are to be shifted by T/2 from the positions of the magnetic poles of the mover in the longitudinal direction (x direction) of the stator, and the positions of the projections of the stator are to be shifted at regular spacing (T/2K) from the positions of the magnetic poles of the mover in the longitudinal direction of the stator in the K sets of stator piece pairs and mover piece pairs.

Therefore, not only the positions of the magnetic poles of K (K=2 in FIG. 2A) mover piece pairs are aligned in the y direction as shown in FIG. 2A, and the positions of the projections of K stator piece pairs are sequentially shifted in the x direction, but also the positions of the projections of K stator piece pairs are aligned in the y direction, and the positions of the magnetic poles of K mover piece pairs can be sequentially shifted in the x direction.

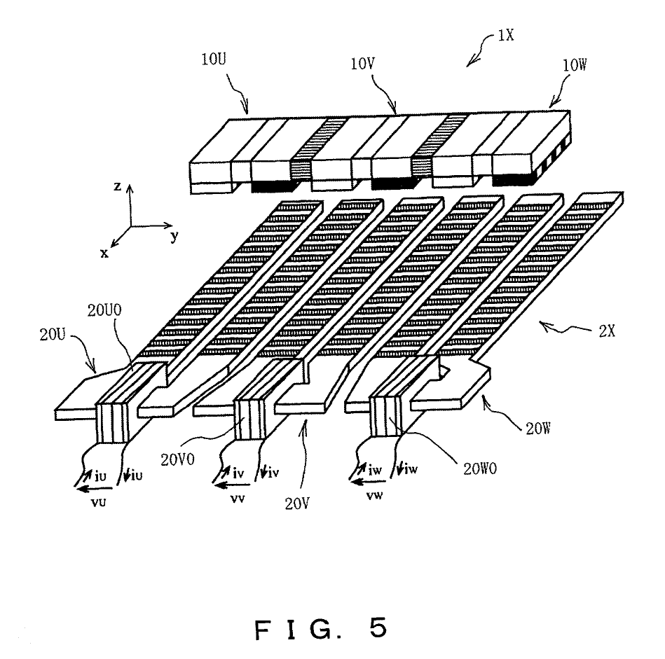

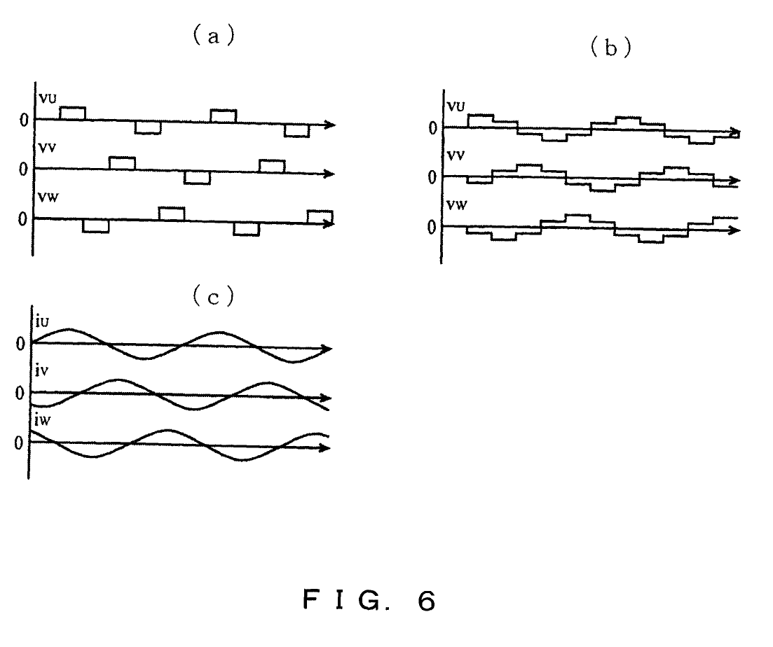

Next, the second embodiment of the present invention is described below by referring to FIGS. 5 and 6. The embodiment corresponds to the third aspect of the present invention.

FIG. 5 is an oblique view of the central portion, and shows the 3-phase configuration of the linear actuator shown in FIG. 2A. 1X denotes a mover. 10U denotes a U-phase mover piece pair. 10V denotes a V-phase mover piece pair. 10W denotes a W-phase mover piece pair. 2X denotes a stator. 20U denotes a U-phase stator piece pair. 20V denotes a V-phase stator piece pair. 20W denotes a W-phase stator piece pair. 20U0 denotes a U-phase coil. 20V0 denotes a V-phase coil. 20W0 denotes a W-phase coil.

The configuration of each of the U-, V-, and W-phase mover piece pairs 10U, 10V, and 10W is the same as the configuration of each of the A- and B-phase mover piece pairs 10A and 10B. The U-, V-, and W-phase stator piece pairs 20U, 20V, and 20W are basically the same as the A- and B-phase stator piece pairs 20A and 20B shown in FIG. 2A in the structure of the bridge, the coil, etc. except that the positions of the projections are shifted by ⅓ pitch (1 pitch indicates the space between adjacent projections) from each other in the x direction.

In this example, the shift of the projections 201 among the U-, V-, and W-phase stator piece pairs 20U, 20V, and 20W is represented by T/K, that is, T/3 where K indicates the number of stator piece pairs (K=3), and T indicates the spacing.

In the embodiment, when the voltage pulses vU, vV, and vW indicated by (a) shown in FIG. 6 are respectively applied to the U-, V-, and W-phase coils 20U0, 20V0, and 20W0, thrust is produced in the mover 1X according to the principle as shown in FIG. 2A. When one end each of the U-, V-, and W-phase coils 20U0, 20V0, and 20W0 is commonly connected to supply a voltage to the three phases and three lines, the sum of the voltages of the phases is 0. Thus, the voltage waveform is shown as (b) in FIG. 6.

In addition, as indicated by (c) shown in FIG. 6, the thrust can be smoothed by using a continuous waveform having a phase difference (the balanced 3-phase sine wave in FIG. 6) for an electric current (or voltage) of each phase.

The linear actuator according to the present invention is not limited to the 2- or 3-phase configuration, but any number of phases other than a single phase can be used in the configuration.

According to the embodiment, the projections of stator piece pairs can be aligned, and the positions of the magnetic poles of stator piece pairs can be sequentially shifted.

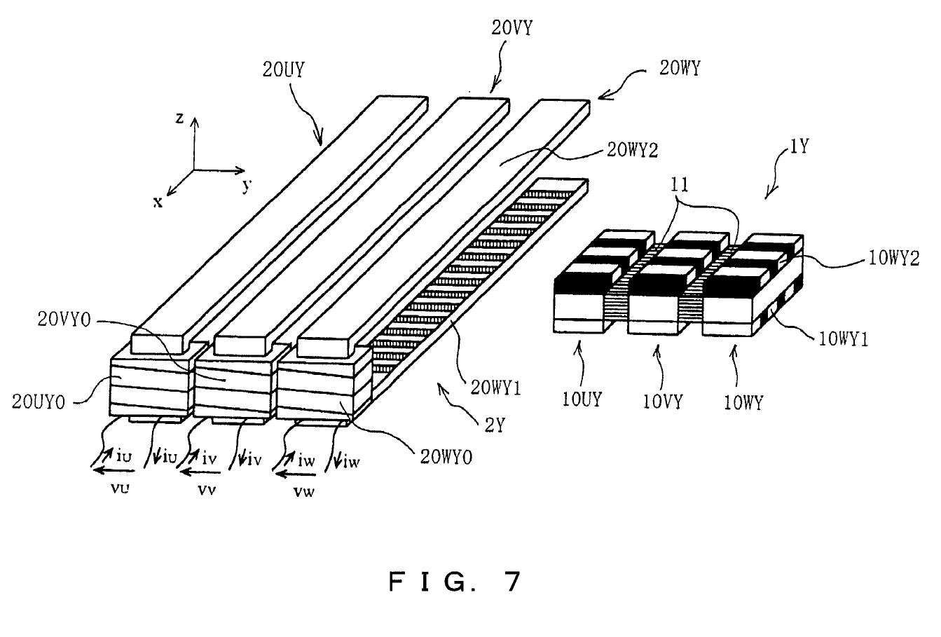

FIG. 7 shows the third embodiment of the present invention, and corresponds to the embodiment according to the fourth aspect of the present invention.

FIG. 7 shows an oblique view of the central portion which is basically a three-phase configuration as shown in FIG. 5. In FIG. 7, 1Y denotes a mover. 10UY denotes a U-phase mover piece pair. 10VY denotes a V-phase mover piece pair. 10WY denotes a W-phase mover piece pair 10WY. 2Y denotes a stator. 20UY denotes a U-phase stator piece pair. 20VY denotes a V-phase stator piece pair. 20WY denotes a W-phase stator piece pair. 20UY0 denotes a U-phase coil. 20VY0 denotes a V-phase coil. 20WY0 denotes a W-phase coil.

In addition, to avoid complexity in FIG. 7, reference numerals of mover pieces 10WY1 and 10WY2 are shown only for the W-phase mover piece pair 10WY of the mover 1Y, and reference numerals of stator pieces 20WY1 and 20WY2 are shown only for the W-phase mover piece pair 20WY of the mover 2Y. However, other U- and V-phase mover piece pairs and stator piece pairs have the same structures as the W-phase pairs.

In the mover 1Y, for example, in the W-phase mover piece pair 10WY, the arrangements of the magnetic poles are inverted between the lower mover piece 10WY1 and the upper mover piece 10WY2 (as in the U- and V-phase mover piece pairs). The arrangements of the magnetic poles between the lower mover pieces and between the upper mover pieces of the mover piece pairs 10UY, 10VY, and 10WY are the same.

In the stator 2Y, there are no pitch shifts in the arrangements of the projections of the facing stator pieces 20WY1 and 20WY2 in the W-phase stator piece pair 20WY (as in the U- and V-phase stator piece pairs) while the projections are shifted by ⅓ pitch in the x direction among the stator piece pairs.

According to the embodiment, the mover 1Y is provided in the [symbol] -shaped space formed by the U-, V-, and W-phase stator piece pairs 20UY, 20VY, and 20WY, and the magnetic poles of the mover piece pairs 10UY, 10VY, and 10WY face the projections of the U-, V-, and W-phase stator piece pairs 20UY, 20VY, and 20WY.

According to the embodiment, since the magnetic force of attraction working between the stator 2Y and the mover 1Y is canceled, the mover 1Y can be easily held.

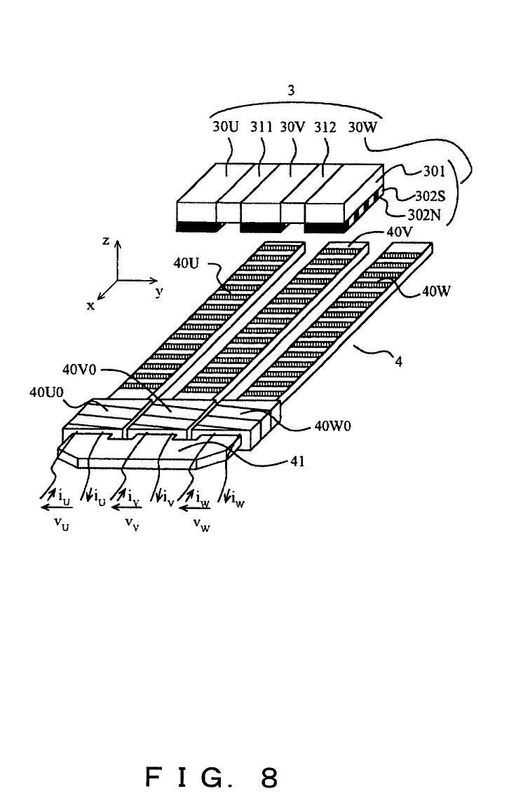

FIG. 8 shows the fourth embodiment of the present invention, and corresponds to the fifth aspect of the present invention.

In FIG. 8, 3 denotes a mover. 30U denotes a U-phase mover piece. 30V denotes a V-phase mover piece. 30W denotes a W-phase mover piece. 311 and 312 denote bridges of a strong magnetic substance. 301 denotes a core. 302N denotes an N magnetic pole. 302S denotes an S magnetic pole. The arrangements of the magnetic poles the same among the U-, V-, and W-phase mover pieces 30U, 30V, and 30W.

On the other hand, 4 denotes a stator. 4DU denotes a U-phase stator piece. 40V denotes a V-phase stator piece. 40W denotes a W-phase stator piece 40W. 40U0 denotes a U-phase coil 40U&. 40V0 denotes a V-phase coil 40V0. 40W0 denotes a W-phase coil 40W0. 41 denotes a bridge of a strong magnetic substance. According to the embodiment, the projections of the U-, V-, and W-phase stator pieces 40U, 40V, and 40W are shifted by ⅓ pitch in the x direction.

That is, the projections are shifted among the U-, V-, and W-phase stator pieces 40U, 40V, and 40W by T/M, that is, T/3, where M (an integer equal to or larger than 2) indicates the number of stator pieces, and T indicates spacing.

The bridge 41 is formed of a strong magnetic substance, and connects and incorporates into one unit the end portions of the U-, V-, and W-phase stator pieces 40U, 40V, and 40W.

According to the above mentioned first through third embodiments, the magnetic circuits of the respective phases are independent. On the other hand, according to the fourth embodiment, the magnetic circuit is shared among the three phases through the bridge 41.

Therefore, the U-, V-, and W-phase stator pieces 40U, 40V, and 40W do not form pairs, but singly work. Correspondingly, the facing U-, V-, and W-phase mover pieces 30U, 30V, and 30W also singly work for each phase.

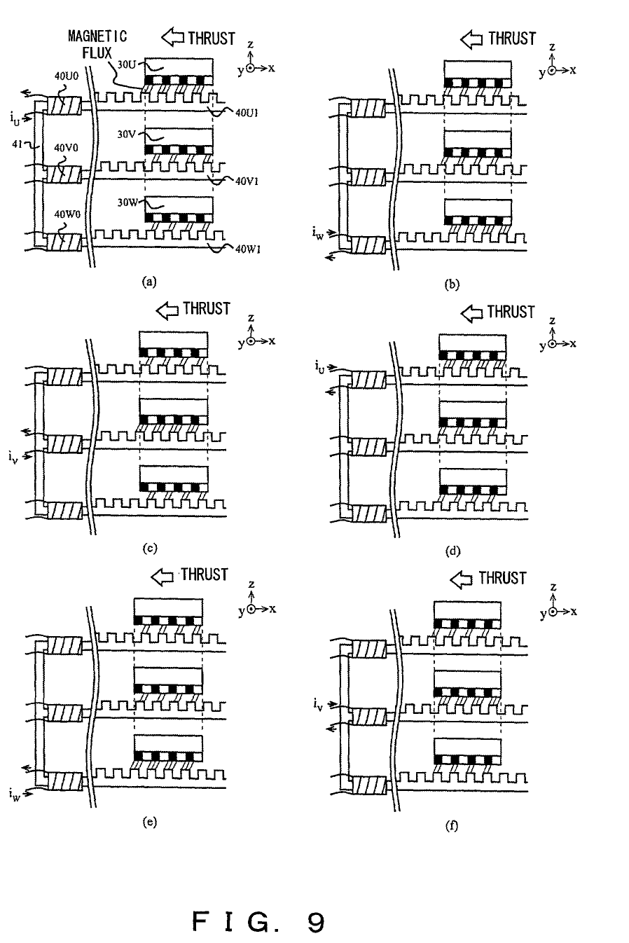

Continuous thrust can be generated in the mover 3 by applying the voltage pulses vU, vV, and vW shown in FIG. 6(a) and 6(b), or the continuous voltage (electric current iU, iV, and iW) having phase difference as shown in FIG. 6 to the U-, V-, and W-phase coils 40U0, 40V0, and 40W0 of the stator 4 shown in FIG. 8. The operations are described below by referring to FIG. 9. FIG. 9 shows the display method similar to the method shown in FIG. 3.

When the electric current iU is applied to the U-phase coil 40U0 when the relative positions between the stator 4 and the mover 3 are as indicated by (a) shown in FIG. 9, the force to align the magnetic poles of the mover and the projections of the stator is generated in the U phase. At this time, since one end (the bridge 41) of the U-, V-, and W-phase stator pieces 40U, 40V, and 40W is magnetically connected to the U-phase mover piece 30U, the magnetic flux passing from the projections of the U-phase stator piece 40U to the magnetic poles of the U-phase mover piece 30U passes through the magnetic poles of the V- and W-phase mover pieces 30V and 30W and the projections of the V- and W-phase stator pieces 40V and 40W, and then through the bridge 41. Thus, the thrust is also produced for the mover 3 in the V and W phases.

According to the above mentioned principle, the mover 3 moves to the position indicated by (b) shown in FIG. 9. Then, if the electric current iW is applied to the W-phase coil 40W0, the thrust is similarly generated.

As indicated by (c) through (f) shown in FIG. 9, the mover 3 moves to 1 pitch from the position indicated by (a) shown in FIG. 9 by sequentially exiting the coil. Therefore, by repeatedly performing the operations (a) through (f) shown in FIG. 9, continuous thrust is produced for the mover 3.

According to the embodiment, since one mover piece and one stator piece are required for each phase, the structure can be simple and small, and any number equal to or larger than 3 can be set for the number of phases.

In the explanation above, the positions of the magnetic poles of each mover piece of the mover are aligned in the x direction while the positions of the projections of each stator piece of the stator are shifted. For example, the positions of the magnetic poles of each mover piece can be shifted, the positions of the projections of each stator piece can be shifted, or the positions on one side of each of the mover and the stator are shifted to obtain the same effect.

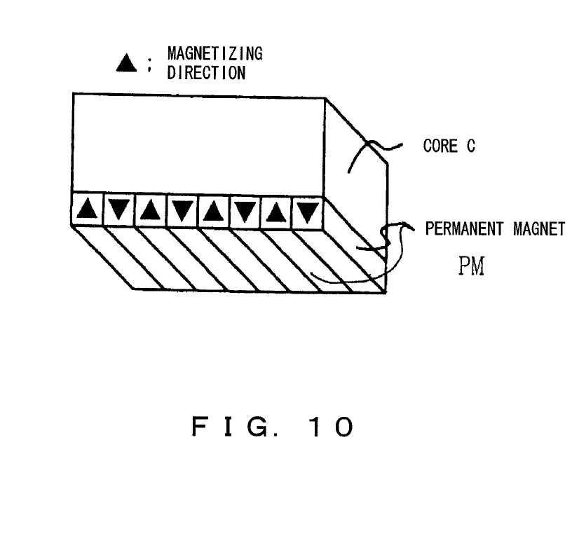

FIG. 10 shows the fifth embodiment of the present invention, and corresponds to the sixth aspect of the present invention.

The linear actuator according to the first through fourth embodiments can be effective so far as the mover pieces have the N and S magnetic poles appearing alternately.

FIG. 10 shows an example of the mover formed from the viewpoint described above, and the N and S magnetic poles are alternately provided with permanent magnets attached under the bottom surface of the core C.

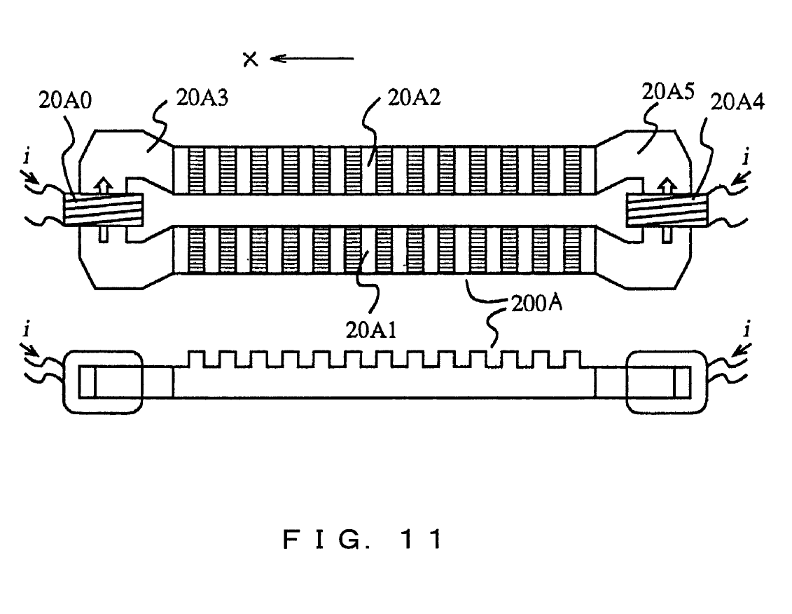

FIG. 11 shows the sixth embodiment of the present invention, and corresponds to the seventh aspect of the present invention. In the embodiment, a bridge and a coil for magnetically connecting each stator piece are also provided on the other end of each stator piece.

In FIG. 11, 200A denotes a A-phase stator piece pair, and corresponds to the A-phase stator piece pair 20A shown in FIG. 2A. The A-phase stator piece pair 200A comprises the stator pieces 20A1 and 20A2 formed by magnetic substances as shown in FIG. 2A. One end of which is magnetically connected by the bridge 20A3. According to the embodiment, the other ends of the A-phase stator pieces 20A1 and 20A2 are also magnetically connected by a bridge 20A5 of a strong magnetic substance.

The coils 20A0 and 20A4 are wound at the central portion of the bridges 20A3 and 20A5. As indicated by the white arrow at the central axis of each coil, the inductive force generated by the coils 20A0 and 20A4 are opposite each other. Practically, the coils 20A0 and 20A4 are equally wound and are provided with the electric current of equal intensity with the polarity inverted.

Although not shown in the attached drawings, the B-phase stator piece pair can also have the same configuration as the A-phase stator piece pair 200A except that it is shifted by ¼ pitch in the x direction from the projections of the A-phase stator pieces 20A1 and 20A2.

The configuration of the stator is the same as the configuration shown in FIG. 2A.

According to the embodiment, the idea of also providing the bridge and the coil for magnetically connecting each stator piece pair for the other end of each stator piece pair can also be applied to the embodiment shown in FIGS. 5 and 7.

If the bridge and the coil are provided on one side only as in the embodiments shown in FIGS. 2A, 5, etc., then the magnetic resistance of the stator piece viewed from the coil is small when the mover is closer to the coil, and large when it is farther from the coil. As a result, the relationship between the thrust and the electric current, and the inductance of the coil depend on the position of the mover. Therefore, it is hard to obtain stable operations when the stator is long.

Accordingly, in the embodiment of the present invention, the bridge and the coil for magnetically connecting the stator piece pairs are provided on both ends of each stator piece pair so that the influence of the position of the mover relative to the coil can be offset, thereby successfully obtaining stable operations.

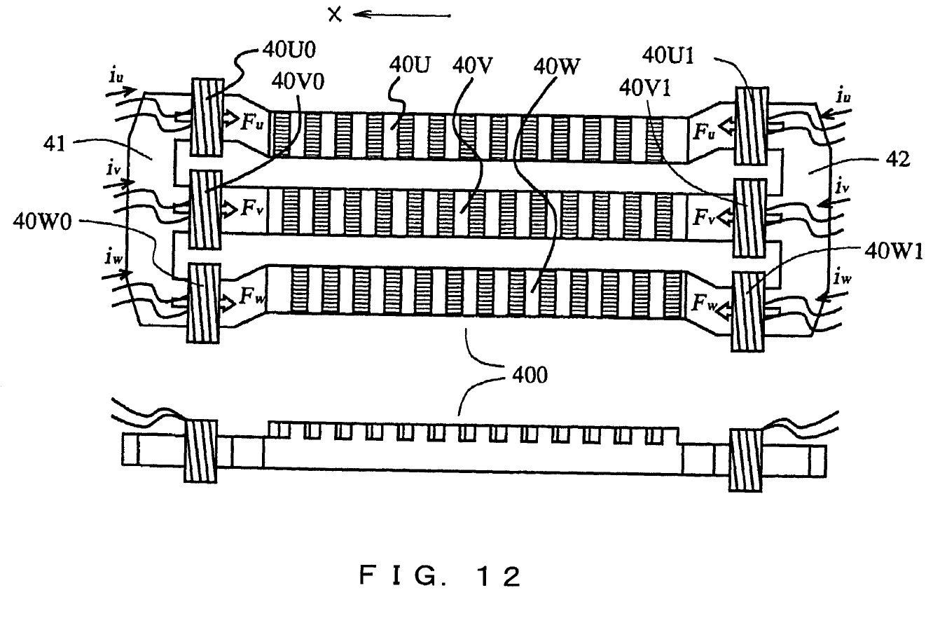

FIG. 12 shows the seventh embodiment of the present invention, and, as in the sixth embodiment, corresponds to the seventh aspect of the present invention. Also according to the embodiment, the bridge and the coil for magnetically connecting each stator piece pair are also provided on both ends of each stator piece pair.

In FIG. 12, 400 denotes a stator, and corresponds to a stator 4. The stator 400 comprises the U-, V-, and W-phase stator pieces 40U, 40V, and 40W of a magnetic substance as shown in FIG. 8. One end of each of the stator piece pairs is magnetically connected by the bridge 41. According to the embodiment, the other end of each of the U-, V-, and W-phase stator pieces 40U, 40V, and 40W is also magnetically connected by the bridge 42 of a magnetic substance.

40U0, 40V0, 40W0, 40U1, 40V1, and 40W1 are coils wound around the bridges 41 and 42. As indicated by the white arrow at the central axis of each coil, the inductive force generated by the coil at both ends of each of the U-, V-, and W-phase stator pieces 40U, 40V, and 40W is inverse in polarity to each other. Practically, an electric current can be applied at the equal intensity level with the equal number of windings of the coils on both ends and inverse polarity.

The configuration of the mover is the same as the configuration shown in FIG. 8.

According to the embodiment, as in the sixth embodiment, the influence of the position of the mover on the coil can be offset to obtain stable operations.

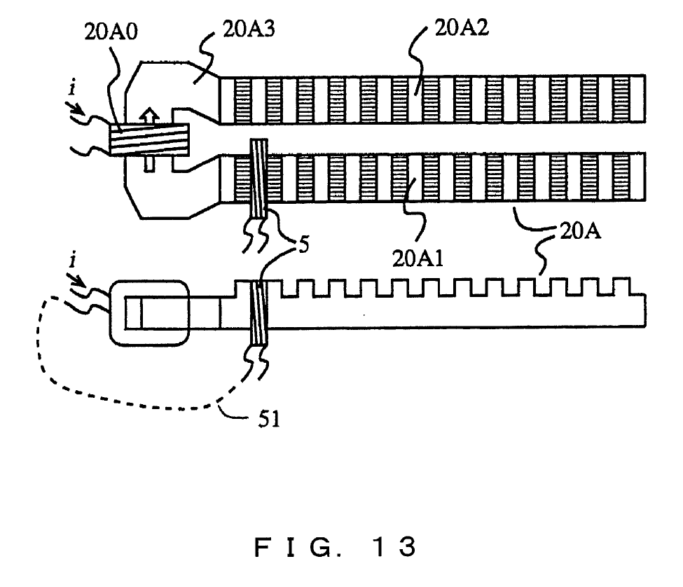

FIG. 13 shows the eighth embodiment of the present invention, and corresponds to the embodiment according to the eighth and ninth aspects of the present invention. According to the embodiment, the absolute position of the stator can be detected by providing a sensor coil 5 in the slot between the projections of stator pieces, and changing the inductance of the sensor coil 5 when the mover passes over the sensor coil 5. Furthermore, the sensor coil 5 can be configured by a part of the coil for driving the mover wound around the bridge of the stator In FIG. 13, 20A denotes a A-phase stator piece pair as shown in FIG. 2A. According to the embodiment, the sensor coil 5 is provided in the slot between the projections of the A-phase stator piece 20A1. The position of the sensor coil 5 is not limited to the example shown in FIG. 13, and the coil can be provided in the slot of the stator piece 20A2.

When the mover moves above the sensor coil 5, the magnetic resistance between the projections is reduced, and the inductance of the sensor coil 5 increases. The change of the inductance of the sensor coil 5 can be easily detected by observing the terminal voltage (and electric current) when a small alternating current is applied (or an alternating voltage is applied) to the sensor coil 5.

Thus, the sensor coil 5 can be used as a ‘positioning origin’, and the mover can be easily positioned without an additional position sensor. Furthermore, for example, the sensor coil 5 can be provided on both ends of a stator piece so as to avoid an overrun of the mover, that is, the sensor coil 5 can be used as a limit switch.

In addition, by connecting a line 51 as shown in FIG. 13, the coil for driving a mover wound around the bridge of a stator, for example, a part of 20A0 can be used as the sensor coil 5.

The idea of providing a stator with a sensor coil for detecting the absolute position of a mover can also be applied to each embodiment shown in FIGS. 5, 7, 8, 11, and 12.

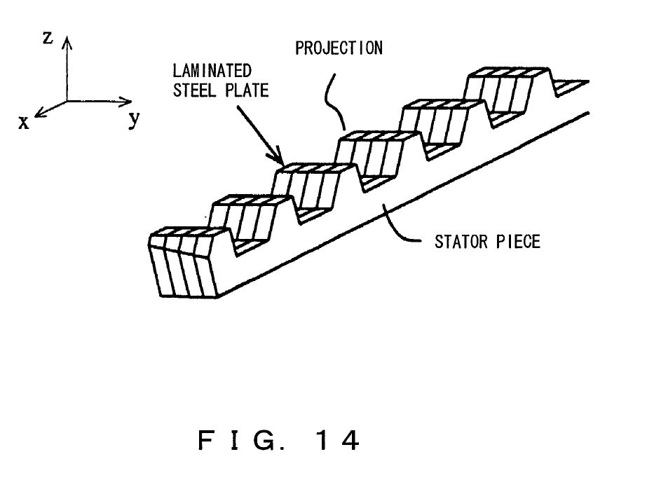

FIG. 14 shows the ninth embodiment of the present invention, and corresponds to the embodiment according to the tenth aspect of the present invention.

An eddy-current loss occurs from alternating magnetic flux in the x direction of the stator, but can be reduced by configuring the stator pieces using a steel plate laminated in the y axis direction.

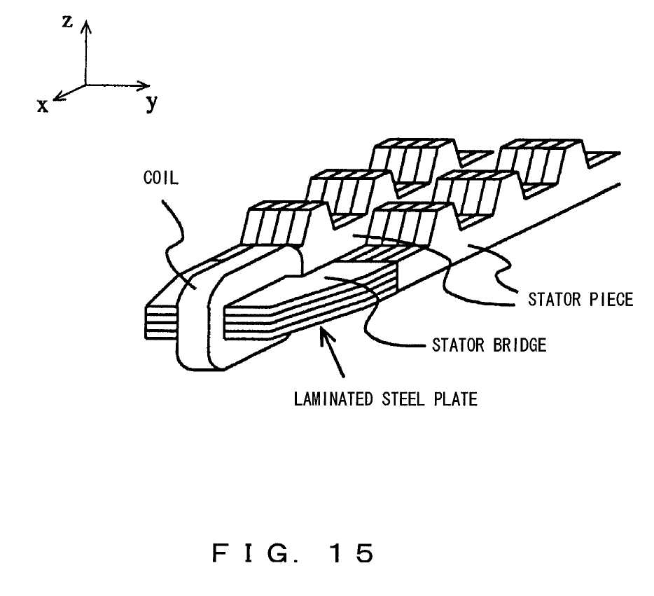

FIG. 15 shows the tenth embodiment of the present invention, and corresponds to the eleventh aspect of the present invention.

According to the embodiment, the bridge is configured by a laminated steel plate so as to reduce the eddy-current loss in the stator bridge. As for the direction of the lamination in this case, the z axis direction is the most preferable for easier production.

In the example shown in FIG. 15, the steel plate is laminated in the y direction for the stator pieces according to the ninth embodiment.

In FIGS. 14 and 15, the idea of configuring the stator pieces and the bridge using a laminated steel plate can also be applied to each of the embodiments shown in FIGS. 5, 7, 8, and 11 through 13.

Described above are various embodiments of the present invention.

In each of the embodiments, the mover has magnetic poles while the stator has coils and projections. However, the relationship between the mover and the stator is relative, and the stator can have magnetic poles while the mover can have coils and projections so far as there is no problem in wiring and weight of coils. In this case, it is not necessary to provide a number of coils along the longitudinal direction of the mover by centrally winding the coil of the mover around the end portion of the mover piece, thereby easily realizing a cooling structure and extending a movable range.

In each of the above mentioned embodiments, the configuration in which the N and S magnetic poles are alternately arranged on the mover piece is described. However, the present invention is not limited to this configuration, and all or a part of the stator piece pair facing surface of the magnetic poles having polarity different from the polarity of the adjacent magnetic pole has to face the groove between the projections when the magnetic poles of the mover piece comprises one or more N and S magnetic poles, and the N or S magnetic poles have the inverse polarity to the projections, thereby realizing the following various structures.

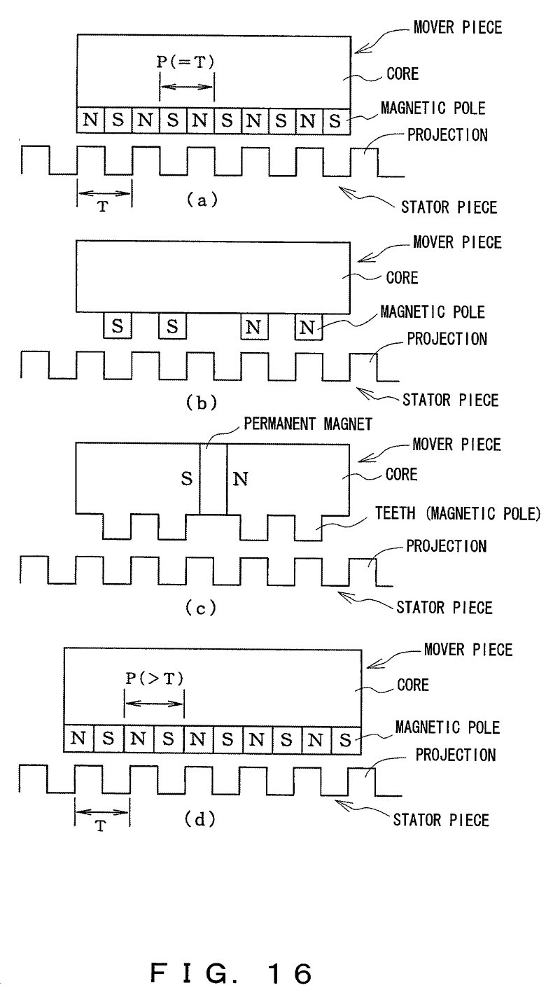

The structure is described below by referring to FIG. 16. First, (a) shown in FIG. 16 shows an example of alternately arranging the N and S magnetic poles on the mover piece as in each of the above mentioned embodiments. In (a) shown in FIG. 16, some of the N and S magnetic poles are removed, and, for example, if the configuration of (b) is used, the N magnetic pole group is biased and faces the groove portion between the projections. Therefore, the thrust of the mover piece is reduced as compared with the case of (a) shown in FIG. 16, which does not cause problems to the operation.

Furthermore, a permanent magnet is applied to the central portion of the core of the mover piece as indicated by (c) shown in FIG. 16 to use the teeth of the core as magnetic poles. Thus, the configuration of using one or a small number of permanent magnets in the core to obtain the function of the original permanent magnet is widely realized in a hybrid stepping motor.

In each of the above mentioned embodiments, the spacing T of the projections of the stator equals the pitch P of the magnetic poles of the mover (P=T) as indicated by (a) shown in FIG. 16. In principle, it can beset in the range of P/2<T<2P. That is, if either N poles or S poles are the magnetic poles inverse to the projections of the stator piece although T≠P, all or a part of the stator piece facing surface of the magnetic poles having inverse polarity to the adjacent magnetic poles is to face the groove portion between the projections.

(d) shown in FIG. 16 shows an example in which P>T and the N magnetic poles at substantially the central portion face the projections of the stator piece, and the majority of the stator piece facing surface of the S magnetic poles adjacent to the N magnetic poles faces the groove portion between the projections. In this case, since the force of aligning each magnetic pole on the projection is dispersed, the thrust of the mover piece is somewhat reduced, but the cogging torque can be considerably reduced.

In addition, in each of the embodiments, the longitudinal direction of the projections and the magnetic poles is orthogonal to the movement direction (x direction) of the mover. However, the cogging torque can be reduced by slightly skewing one or both of projections and magnetic poles.

Although not described in each of the embodiments, a sensor of detecting the position of the mover is provided, and the feedback control system is configured according to the positional information about the mover obtained by the sensor, thereby controlling the position of the mover with high precision.

As described above, according to the present invention, it is not necessary to arrange coils in the entire range of the mover and the stator, and the coils are centrally wound around the end portions in the longitudinal direction of the stator, thereby easily performing the cooling operation and simplifying the radiating structure. Furthermore, since no coils are provided for the mover, the movable range of the mover can be extended, and a practical and less expensive linear actuator can be successfully configured.

What is claimed is:

1. A linear actuator, comprising:
a stator having a coil wound around an end portion of a rail-shaped magnetic substance; and
a mover which faces a rail-shaped portion of said stator, relatively moves along the rail-shaped portion, and includes a magnetic substance, wherein
an electric current flows through the coil to centrally produce magnetic flux on the rail-shaped portion facing said stator, thereby obtaining magnetic thrust of said mover.

2. A first component which is formed by rail-shaped magnetic pieces in substantially parallel rows, each of which has a coil wound around at an end portion of a longitudinal direction of the piece and makes a periodical magnetic change along the longitudinal direction of the piece by flowing an electric current through the coil; and
a second component facing said first component at predetermined spacing, and having N and S magnetic poles along the longitudinal direction of the plurality of pieces, wherein
said second component can be moved relative to said first component along the longitudinal direction of said first component by differentiating distribution of magnetic changes of the plurality of pieces of said first components on a surface facing said second component.

3. A linear actuator, comprising:
a stator having K (K indicates and integer equal to or larger than 2) stator piece pairs, and each stator piece pair is composed of two stator pieces which are parallel-placed rail-shaped magnetic substances having a plurality of projections arranged at regular spacing T in a longitudinal direction, a bridge made by magnetic substance connecting one end of each stator piece together magnetically, and a coil wound around the bridge to magnetize the two stator pieces for opposite polarities; and
a mover having K mover piece pairs, and each mover piece pair is composed of magnetically-connected two mover pieces which are faced at predetermined spacing to said two stator pieces one to one which comprise said stator piece pair, and each mover piece has a magnetic core and magnetic poles formed on a portion of the magnetic core facing to said stator piece and arranged such that all or part of the N poles face to projections of the stator piece when all or part of the S poles face to slots between the projections, wherein:
in each of K sets of one stator piece pair and one mover piece pair facing to each other,
two sets of a stator piece and a mover piece facing to each other are arranged such that positions of the magnetic poles on the mover piece to the projections on the stator piece in one set are shifted relative to those of the other set by T/2 in the longitudinal direction of said stator;
with the K sets of one stator piece pair and one mover piece pair, the positions of the magnetic poles on the mover pieces to the projections on the stator pieces are sequentially shifted relative to each other at regular spacing along the longitudinal direction of said stator; and
thrust along the longitudinal direction of said stator can be produced on said mover by sequentially applying an electric current to a coil of each stator piece pair in a time series.

4. The linear actuator according to claim 3, wherein:
said stator piece pair is formed such that the projections of its two stator pieces face to each other; and
said mover piece pair is provided between the two stator pieces in the stator piece pair corresponding to the mover piece pair.

5. A linear actuator, comprising:
a stator having M (M indicates an integer equal to or larger than 3) stator pieces, each of which is formed by a rail-shaped magnetic substance having a plurality of projections arranged at regular spacing in a longitudinal direction, and which are arranged parallel to each other, with one end of the stator pieces magnetically connected, and with a coil situated to each of the stator pieces to magnetize the projections; and
a mover having M mover pieces, which are faced at predetermined spacing to said stator pieces one to one, and each mover piece has a magnetic core, which is magnetically-connected to the cores of adjacent mover pieces, and magnetic poles formed on a portion of the magnetic core facing to said stator piece and arranged such that all or part of the N poles face to projections of the stator piece when all or part of the S poles face to slots between the projections, wherein:
with M sets of one stator piece and one mover piece facing to each other, the positions of the magnetic poles on the mover pieces to the projections on the stator pieces are sequentially shifted relative to each other at regular spacing along the longitudinal direction of said stator; and
thrust along the longitudinal direction of said stator can be produced on said mover by sequentially applying an electric current to a coil of each stator piece in a time series.

6. The linear actuator according to claim 3, wherein
said mover piece is configured by closely coupling a core of a strong magnetic substance with a permanent magnet as a magnetic pole.

7. The linear actuator according to claim 4, wherein
said mover piece is configured by closely coupling a core of a strong magnetic substance with a permanent magnet as a magnetic pole.

8. The linear actuator according to claim 5, wherein
said mover piece is configured by closely coupling a core of a strong magnetic substance with a permanent magnet as a magnetic pole.

9. The linear actuator according to claim 3, wherein
said bridge to connect the stator pieces magnetically and said coils are also provided at the other end of the stator.

10. The linear actuator according to claim 4, wherein
said bridge to connect the stator pieces magnetically and said coils are also provided at the other end of the stator.

11. The linear actuator according to claim 5, wherein
said bridge to connect the stator pieces magnetically and said coils are also provided at the other end of the stator.

12. The linear actuator according to claim 6, wherein
said bridge to connect the stator pieces magnetically and said coils are also provided at the other end of the stator.

13. The linear actuator according to claim 3, wherein
a sensor coil is wound in a slot between the projections of said stator pieces, and an absolute position of said mover can be detected based on a change of inductance of the sensor coil made when said mover passes over the sensor coil.

14. The linear actuator according to claim 4, wherein
a sensor coil is wound in a slot between the projections of said stator pieces, and an absolute position of said mover can be detected based on a change of inductance of the sensor coil made when said mover passes over the sensor coil.

15. The linear actuator according to claim 5, wherein
a sensor coil is wound in a slot between the projections of said stator pieces, and an absolute position of said mover can be detected based on a change of inductance of the sensor coil made when said mover passes over the sensor coil.

16. The linear actuator according to claim 6, wherein
a sensor coil is wound in a slot between the projections of said stator pieces, and an absolute position of said mover can be detected based on a change of inductance of the sensor coil made when said mover passes over the sensor coil.

17. The linear actuator according to claim 9, wherein
a sensor coil is wound in a slot between the projections of said stator pieces, and an absolute position of said mover can be detected based on a change of inductance of the sensor coil made when said mover passes over the sensor coil.

18. The linear actuator according to claim 13, wherein
said sensor coil is configured by a part of a coil for driving said mover wound around the bridge of said stator.

19. The linear actuator according to claim 14, wherein
said sensor coil is configured by a part of a coil for driving said mover wound around the bridge of said stator.

20. The linear actuator according to claim 15, wherein
said sensor coil is configured by a part of a coil for driving said mover wound around the bridge of said stator.

21. The linear actuator according to claim 16, wherein
said sensor coil is configured by a part of a coil for driving said mover wound around the bridge of said stator.

22. The linear actuator according to claim 17, wherein
said sensor coil is configured by a part of a coil for driving said mover wound around the bridge of said stator.
